(19) United States
(12) Patent Application Publication
(10) Pub. No.: US 2015/0355227 A1
(43) Pub. Date: Dec. 10, 2015

(54) OPTICALLY GUIDED MICRODEVICE COMPRISING A NANOWIRE

(71) Applicant: DANMARKS TEKNISKE UNIVERSITET, Lyngby (DK)

(72) Inventor: Jesper GLÜCKSTAD, Frederiksberg (DK)

(73) Assignee: Danmarks Tekniske Universitet, Lyngby (DK)

(21) Appl. No.: 14/759,313

(22) PCT Filed: Jan. 10, 2014
(86) PCT No.: PCT/DK2014/050004

§ 371 Date: Jul. 6, 2015

Related U.S. Application Data
(60) Provisional application No. 61/751,691, filed on Jan. 11, 2013.

(30) Foreign Application Priority Data
Jan. 11, 2013 (EP) 13150969.7

(51) Int. Cl. G01Q 60/22

(52) U.S. Cl. CPC G01Q 60/22; B82Y 15/00

(57) ABSTRACT

The present invention relates to a microdevice (100) for emitting electromagnetic radiation onto an associated object. Simultaneous non-contact spatial control over the microdevice in terms of translational movement in three dimensions, and rotational movement around at least two axes, preferably three axes, is possible. The microdevice further comprises a nanowire (150) being arranged for emitting electromagnetic radiation onto said associated object. This is advantageous for obtaining better spatial control of the microdevice comprising the nanowire, and this enables that light could more effectively be coupled into the nanowire. This opens up for a much wider application of nanowires in optics because of the improved spatial control.

### FIELD OF THE INVENTION

The present invention relates to a microdevice for investigating or analyzing an associated object, and more specifically to a device and a method for facilitating investigating or analyzing an associated object with electromagnetic radiation.

### BACKGROUND OF THE INVENTION

Within the field of investigation or analyzing objects with electromagnetic radiation it is of constant appeal to be able to improve the instruments used to gain information about the examined objects. For example, it is a desire to improve the spatial resolution. Another desire is to expand the types of objects which can be examined. The field has spawned a large number of techniques which each have contributed to the general progress of the field. Examples include confocal microscopy and scanning near field optical microscopy. Recently, the use of nanowires has attracted attention. Inorganic nanowires may have diameters substantially below the wavelength of visible light, and their optical properties make them attractive for nanometre photonics.

WO 2007/079411 to Regents of Univ. of California discloses a method for manipulating, handling and integration of nanowires using optical trapping. Individually trapping, transferring, and assembling high-aspect-ratio semiconductor nanowires into arbitrary structures are performed in a fluid environment. Nanowires with diameters as small as 20 nm and aspect ratios of above 100 can be trapped and transported in three dimensions, enabling the construction of nanowire architectures, which may function as active photonic devices on a microscopic scale. Moreover, nanowire structures can now be assembled in physiological environments. E.g. a nanowire may be attached to an inorganic or organic structure. In one aspect, nanowires are positioned to direct light to remote samples, reducing exposure of the overall sample to intense source illumination. This reference within the field of optically controllable devices, describes an objective in terms of employing a nanowire for directing light to and from an object to be examined. However, it may be problematic to be able to radiate light to and from the nanowire, particularly because the nanowire is not freely moveable, both with respect to translation and rotation, relative to the controlling beams of radiation.

WO 2012/155919 A1 describes a microdevice for emitting electromagnetic radiation, the microdevice being adapted so as to be controllable by electromagnetic radiation, such as light. The microdevice comprises a first electromagnetic radiation emitting unit arranged to emit electromagnetic radiation, so as to be able to irradiate electromagnetic radiation onto a structure of interest. The microdevice further comprising means for enabling non-contact spatial control over the microdevice in terms of translational movement in three dimensions, and rotational movement around at least two axes. The present invention thus provides an instrument which enables controlled irradiation of light onto very well defined areas on the nano-scale of objects of interest. Furthermore, the device enables receipt of light and may thus work as an optically controlled microendoscope.

In WO 2006/008550 A1 a device for manipulation by a plurality of optical traps is disclosed. Connected trapping elements such as transparent beads are also connected to a tip, which is spaced from the trapping elements by a distance greater than the effective range of the optical trapping fields.

The work presented in the article “Wave-guided optical waveguides” (Optics Express, Vol. 20, Issue 3, pp. 2004-2014 (2012) by D. Palima, A. R. Bañas, G. Vizsnyiczai, L. Kelemen, P. Ormos and J. Glückstad, primarily aims to fabricate and use two photon polymerization (2PP) microstructures capable of being optically manipulated into any arbitrary orientation. The authors, which overlap with the present inventors, have integrated optical waveguides into the structures and therefore have freestanding waveguides, which can be positioned anywhere in the sample at any orientation using optical traps. One of the key aspects to the work is the change in direction of the incident plane wave, and the marked increase in the numerical aperture demonstrated. Hence, the optically steered waveguide can tap from a relatively broader beam and then generate a more tightly confined light at its tip. The paper contains both simulation, related to the propagation of light through the waveguide, and experimental demonstrations using their BioPhotonics Workstation. In a broader context, this work shows that optically trapped microfabricated structures can potentially help bridge the diffraction barrier. This structure-mediated paradigm may be carried forward to open new possibilities for exploiting beams from far-field optics down to the subwavelength domain.

Hence, an improved microdevice for investigating or analyzing an associated object would be advantageous, and in particular a more efficient and/or reliable microdevice for investigating or analyzing an associated object would be advantageous.

### OBJECT OF THE INVENTION

It is a further object of the present invention to provide an alternative to the prior art.

In particular, it may be seen as an object of the present invention to provide a microdevice that solves the above mentioned problems of the prior art with improved control of the nanowire applied for nanoscale photonics.

### SUMMARY OF THE INVENTION

Thus, the above described object and several other objects are intended to be obtained in a first aspect of the invention by providing a microdevice for emitting electromagnetic radiation onto an associated object, the microdevice comprising
a first electromagnetic radiation emitting unit arranged to emit electromagnetic radiation, and
means for enabling simultaneous non-contact spatial control over the microdevice in terms of:
   translational movement in three dimensions, and
   rotational movement around at least two axes, preferably three axes,
      wherein the means for enabling non-contact spatial control over the microdevice are arranged for being spatially controlled by forces applied by electromagnetic radiation,
      wherein the first electromagnetic radiation emitting unit and the means for enabling spatial control over the microdevice are structurally linked, and
      wherein the microdevice further comprises a nanowire being arranged for receiving electromagnetic radiation emitted from the first electromagnetic radiation emitting unit and emitting electromagnetic radiation onto said associated object.

The invention is particularly, but not exclusively, advantageous for obtaining better spatial control of the microdevice comprising the nanowire, and this enables that light, or more generally electromagnetic radiation, could more effectively be coupled into the nanowire. This opens up for a much wider application of nanowires in optics because of the much improved spatial control that hitherto was not possible, i.e. a nanowire was not freely controllable in five, preferably six, degrees of freedom (DOF) provided by the present invention. One particularly interesting application is in medical analysis, or endoscopic analysis, where single cell imaging and/or micro/nano-spectroscopy is made feasible by the present invention due to the improved spatial control.

Other advantages of particular embodiments of the invention are outlined in the following section. Bringing photonics tools into the nanoscale is typically challenged by the classical diffraction barrier. Overcoming the diffraction challenge for imaging entails either using near-field approaches or far-field optics that exploits nonlinear optical processes. Beyond imaging, photonics can also leverage nanoscopic activation, probing and manipulation.

The invention solves, in particular embodiments, the problem of providing a subwavelength source having the tuneability of advanced laser systems, which can be manoeuvred in the nanoscale. The invention proposes, in a particular embodiment, a novel approach using structure-mediated micro-to-nano coupling by using the nanowire for optical purposes. The present application suggests in particular embodiments, a microdevice that channels optical force and optical energy from far-field optics into the subwavelength domain together with the advantages provided by a nanowire functioning as emitter and/or receiver.

The microdevice, which may typically be fabricated by two-photon photopolymerization (2PP), can couple mechanical force from the optically trapped handles to achieve up to six degree-of-freedom (6DOF) control over a nanotool. This microdevice can also channel arbitrary light sources into its sub-diffraction limit nanowire-tapered tip. Handling these microdevices using, e.g., a BioPhotonics Workstation enables real-time 6DOF nanotool control and targeted light delivery. This sets the stage for calibrated steering of functionalized nanotools and effectively creates a versatile subwavelength light source, limited only by available light sources themselves. This opens up for new avenues for far-field optics in subwavelength photonics and its wide ranging applications in the natural sciences.

‘Electromagnetic radiation’ (EMR) is well-known in the art. EMR is understood to include various types of electromagnetic variation, such as various types corresponding to different wavelength ranges, such as radio waves, microwaves, infrared radiation, EMR in the visible region (which humans perceive or see as ‘light’), ultraviolet radiation, X-rays and gamma rays. The term optical is to be understood as relating to light. EMR is also understood to include radiation from various sources, such as incandescent lamps, LASERs and antennas. It is commonly known in the art, that EMR may be quantized in the form of elementary particles known as photons. In the present application, the terms ‘light’ and ‘optical’ is used for exemplary purposes. It is understood, that where ‘light’ or ‘optical’ is used it is only used as an example of EMR, and the invention is understood to be applicable to also other wavelength intervals where reference is made to ‘light’ or ‘optical’.

By ‘microdevice’ is understood a device on the scale of micrometres, such as a device having length, width and height within a range from 1 micrometre to 1 millimetre. Possibly, the scale can be smaller or larger depending on the application.

By ‘EMR unit’ is understood a unit which is capable of emitting EMR. The EMR may redirect EMR which is received by the EMR unit, such as the EMR unit being a mirror or a lens, or the EMR unit may comprise an emitter capable of generating the EMR which the EMR unit emits.

By ‘EMR emitting unit’ is understood a unit which is capable of emitting EMR, such as capable of emitting EMR to the nanowire. The EMR emitting unit may redirect EMR which is received by the EMR emitting unit, such as the EMR emitting unit being a mirror or a lens or a light guide, or the EMR emitting unit may comprise an emitter capable of generating the EMR which the EMR emitting is capable of emitting. Such emitter may be given by, e.g., a laser which may be pumped by an external light source, or a light emitting diode which is driven by a source of current integrated within the microdevice, or the emitter may comprise a luminescent material. It may thus be understood, that the EMR emitting unit may, for example, comprise a light in-coupling element (e.g., in case the EMR emitting unit is based on receiving and re-emitting light, which is not necessarily the case for all EMR emitting units), a light out-coupling element (in case light originates from within the EMR emitting unit, which is not necessarily the case for all EMR emitting units) and optionally a light-guiding element, e.g., so that light may be received at a light in-coupling element and guided by a light guiding element to a light out-coupling element where it may be emitted, e.g., to the nanowire. In an embodiment, the EMR emitting unit comprises a light in-coupling element and a separate light out-coupling element, and optionally a light-guiding element. In an embodiment, the EMR emitting unit comprises an element which is capable of dual functioning as a light in-coupling element and as a light out-coupling element. In an embodiment, the EMR emitting unit may not comprise a light in-coupling element, such as the EMR emitting unit comprising an emitter capable of generating the EMR which the EMR emitting unit emits and the EMR emitting unit not comprising a light in-coupling.

By ‘EMR receiving unit’ is understood a unit which is capable of receiving EMR, such as a unit being capable of receiving EMR from the nanowire and/or further transmitting EMR, such as a unit being capable of of receiving EMR from the nanowire and further transmitting the EMR. The EMR receiving unit may redirect EMR which is received by the EMR receiving unit, such as the EMR receiving unit being a mirror or a lens. It may be understood, that the EMR receiving unit may, for example, comprise a light in-coupling element, a light out-coupling element and optionally a light-guiding element, e.g., so that light may be received at a light in-coupling element and guided by a light guiding element to a light out-coupling element where it may be emitted (i.e., further transmitted), e.g., to an optical unit capable of receiving EMR representative of e.g. image(s) of the associated object. In an embodiment, the EMR receiving unit comprises a light in-coupling element and a separate light out-coupling element, and optionally a light-guiding element. In an embodiment, the EMR receiving unit comprises an element which is capable of dual functioning as a light in-coupling element and as a light out-coupling element.

By ‘means for enabling simultaneous non-contact spatial control’ is understood physical features which enable spatial movement and/or displacement of the microdevice without having any mechanical contact to the microdevice, or similar physical means of contact, e.g. spatial movement and/or displacement control by electromagnetic radiation radiated upon the microdevice in controlled directions and quantities.

By ‘translational movement’ is understood movement where the microdevice is moved from a first position in space to a second position in space. It is understood that there are three spatial dimensions (corresponding to three axis—x, y, and z—in a Cartesian coordinate system), and translational movement in three dimensions thus corresponds to enabling movement in all directions.

By ‘rotational movement’ is understood movement where the microdevice is rotated—a certain angle—around its own centre of gravity. It is understood that there are three spatial dimensions (corresponding to three axis—x, y, and z—in a Cartesian coordinate system), and rotational movement in three dimensions thus corresponds to enabling movement around all axes. Control over rotational movement of a device around at least two axes means that the rotation of the device around 2 axes is controlled, while rotation of the device around the last axis is not necessarily controlled.

Means for enabling simultaneous non-contact spatial control over the microdevice in terms of translational movement in three dimensions, and rotational movement around at least two axes may alternatively be formulated as means for enabling simultaneous control over 3 translational degrees of freedom and 2 rotational degrees of freedom, i.e., a total of 5 degrees of freedom, preferably 6 degrees of freedom with 2 rotational degrees of freedom. This may be advantageous since it allows placing the microdevice in any position and any orientation. For example, the microdevice may be moved around a human cell while always being oriented toward the centre of the cell, such as having the nanowire emitting electromagnetic radiation toward the centre of the cell. In particular embodiments, said means may be embodied in the form of EMR controllable handles, such as optical handles.

A nanowire may be understood to be an elongated body in the context of the present application. A shape of a cross-section of the nanowire, in a plane orthogonal to a centre axis in a lengthwise direction of the nanowire, might typically be circular, or substantially circular. However, the invention is understood to comprise other shapes, as well, in particular other shapes such as elliptical, polygonal, rectangular, quadratic, or triangular. An advantage of a cross-section which is non-circular is that it might be possible to achieve polarization control and thus improved performance. It is further understood that expressions, examples, calculations, and figures here and elsewhere in the description, claims, and figures which refer to the invention as having a circular shape of a cross-section of the nanowire are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure it is not intended to be limited to the specific form set forth herein.

The concept of a nanowire may generally be understood as a nanostructure having a diameter at the order of nanometers (nm) and having high aspect ratios (e.g. 100, 500, 1000 or more) enabling physical phenomena that may be approximated as occurring in one dimension (1-D). Electrons may accordingly be quantum confined laterally facilitating effects in e.g. optics and opto-electronics not typically seen in bulk materials. Nanowires therefore have a number of advantageous optical capabilities that can be utilised in the context of the present invention. Notice that nanowires are known also as ultra-thin optical fibers, micro/nano optical wires (MNOW), photonic nanowires, subwavelength waveguides, etc. It may be mentioned that nanowires are widely known as difficult to handle during spatial manipulation, but this problem is minimized, or obviated, by the present invention facilitating optically controllable ‘handles’ i.e. the microdevice with 5/6DOF control.

In a particular embodiment, the nanowire may enable nano-spectroscopy with wavelengths below the conventional diffraction limit in optics, i.e. opening a completely new area of spectroscopy with the 5/6DOF manipulation enabled by the microdevice according to the present invention.

Similarly, the recent concept of nanowires functioning effectively as “nanoantennas” i.e. having directionality in the emission properties may enable strongly enhanced efficiency in the nanowire properties e.g. when functioning as an LED, a nanolaser, or even as a single photon source with optimized efficiency and/or controlled emission by the geometry, cf. “Nanowire antenna emission” by G. Grezela et al. in Optics Letter, 12, 11, p. 5481-6, November 2012.

In the context of the present invention, the nanowire can be suitably manufactured in some embodiments in a single material such a metal (e.g. Ag, Au), semiconductor (e.g. Si, GaN), polymer, silica, nonlinear crystal (e.g. ZnO, KnbO₃), biofriendly SnO₂, graphene etc.

In other embodiments, the nanowire can be suitably manufactured in a composite material having several appropriate materials for providing an overall desirable optically working nanowire. In particular, the nanowire may be manufactured with an inner core of one material, e.g. glass, and one or outer materials, preferably arranged in a peripheral manner with respect to the inner core, to more complete or particular reflection on the edges of the nanowire. In a specific embodiment, the nanowire may be metal coated (e.g. silver or gold) so as to include possible surface plasmons coupled with photons to yield i.e. surface plasmon polaritons (SPPs) to be utilised in the context of the present invention.

In some embodiment, the nanowire and microdevice may be manufactured in different materials, but they could also, as a special case, be manufactured in the same kind of material.

In a particular advantageous application, the present invention may be applied for medical or biological analysis in general, and more specifically for a nanowire-based optical probe for (single-cell) endoscopic approaches. In this case, the microdevice would have a nanowire waveguide fixed to a tapered tip of a waveguide in the microdevice for subsequent insertion into a living cell at designated positions using the full 3D real-time, 6 DOF optical manipulation of the optical handling means. Such a microscopic probe can be optically coupled to either an excitation laser to function as a local light source for sub-cellular imaging, or reversely to a spectrometer to collect local photo-excitable signals. Such a microscopic endoscope can be e.g. realized by merging a bio-friendly SnO₂ nanowire to the tip of a tapered single-mode waveguide structure in a microdevice according to the present invention.

Such microdevices may be highly useful for interrogating intracellular environments due to their small dimensions and mechanical flexibility that will minimize the damage they will potentially inflict on cellular structures and organelles. Importantly, because of the nanowire's typically higher refractive index (n≈2.1-2.2 for semiconductor) than that of the microdevice itself (n≈1.5 for SU8), the nanowire tapering can potentially guide visible light very efficiently in high-index physiological liquids and living cells where refractive indices are typically in the range n≈1.3-1.4.

In some embodiments, the first electromagnetic radiation emitting unit may comprise:
an electromagnetic radiation in-coupling element arranged to receive incoming electromagnetic radiation, and
an electromagnetic radiation out-coupling element being structurally linked to the electromagnetic radiation in-coupling element and the electromagnetic radiation out-coupling element being arranged to emit electromagnetic radiation in response to said incoming electromagnetic radiation,
   wherein the electromagnetic radiation out-coupling element is structurally and optically connected to said nanowire for emitting electromagnetic radiation.

In one embodiment, the electromagnetic radiation out-coupling element may be structurally and optically connected to said nanowire for emitting electromagnetic radiation, the nanowire further being optically and structurally arranged for performing lasing with an appropriate incoming electromagnetic radiation receivable by the electromagnetic radiation out-coupling element, the first electromagnetic radiation emitting unit may optionally function as pump laser for the nanowire, the nanowire preferably functioning as a high Q laser with an appropriate nanocavity, or alternatively the first electromagnetic radiation emitting unit (possible with appropriate optical guide elements) may guide dedicated pump radiation from outside the microdevice towards the nanowire where the lasing is performed. Various other optical phenomena may similarly be implemented in the nanowire as explained above.

Preferably, the electromagnetic radiation out-coupling element may have a tapered structure, more preferably the narrow end of the tapered structure being structurally connected to said nanowire. Additionally or alternatively, the nanowire may have a tapered structure, preferably the wider end of the tapered structure being structurally connected to said first electromagnetic radiation emitting unit, the narrow end of the tapered structure of the nanowire being arranged for emitting electromagnetic radiation.

Advantageously, the nanowire may be chosen from the group consisting of: a metallic nanowire, a semiconductor nanowire, a ceramic nanowire, an insulator nanowire, a molecular nanowire, such as nanotubes (incl. carbon nanotubes). The nanowire should be optically conducting so as to convey EMR through the wire. In particular, it is worth mentioning that the present invention, when implemented with a metallic nanowire, may facilitate tip-enhanced Raman spectroscopy (TERS). In conventional TERS, the diffraction limit is avoided by applying SPP induced plasmonic enhancement and light confinement near a metallic nanostructure, c.f. a recent review by Prabbat Verma et al. in Laser Photonics Rev. 4, No. 4, 548-561 (2010), which is hereby incorporated by reference in its entirety. It is contemplated the present invention may facilitate TERS by use of the nanowire integrated with the microdevice in a new and advantageous manner, where the microdevice according to the present invention will have a much improved spatial control and not being so sensitive with respect to the surrounding environment, at least relative to a TERS implementation using for example an atomic force microscopy (AFM) with a metal coated tip.

In some embodiment, the nanowire may have an effective refractive index substantially larger than an effective refractive index of the first electromagnetic radiation emitting unit, preferably with a graded a transition between the two refractive indexes in order to provide an optimal interface. Thus, the nanowire may be made of a different material than the remaining part of the microdevice.

The nanowire may be made in a material having an effective refractive index substantially larger than an effective refractive index of the first electromagnetic radiation emitting unit, preferably with a graded transition between the two refractive indexes.

The nanowire may in an advantageous embodiment further be optically arranged for receiving electromagnetic radiation from an associated object and transmit it to the first electromagnetic radiation emitting unit, this unit also being arranged for transmitting the said electromagnetic radiation out of the microdevice, the microdevice thereby functioning as a bi-directional optically device. This facilitates the use of the microdevice as an optical probe being optically displaceable. The microdevice with the nanowire may be considered as a moveable extension or ‘local lens’ of e.g. optical equipment applied for optical imaging or analysis.

Preferably, the nanowire may be manufactured in a biofriendly material suitable for endoscopic application, such as SnO₂, and graphene. In fact, the present invention facilitates a new area of micro- or nano-endoscopic applications rendering e.g. intra-cellular endoscopic analysis feasible as explained in more detail above.

The electromagnetic radiation in-coupling element may be arranged to receive incoming electromagnetic radiation having a first direction and the electromagnetic radiation out-coupling element may be arranged to emit electromagnetic radiation having a second direction where the first direction and the second direction are non-parallel, alternatively the first direction and the second direction are parallel but displaced, more alternatively where the first direction and the second direction are anti-parallel. This is advantageous in order to provide improved inspection of objects having complex shapes and/or sizes, which makes a turned direction of inspection desirable.

The microdevice may preferably comprise an electromagnetic radiation guiding element for optically connecting at least the electromagnetic radiation in-coupling element with the electromagnetic radiation out-coupling element.

In one embodiment, the means for enabling spatial control over the microdevice may comprise at least one electromagnetic radiation controllable handle, but typically more than one handle is provided, e.g. 2, 3, 4, 5, 6, 7, 8, 9, 10 or more. The handle(s) may have a structural link, or arm, separated it from the microdevice core, or optical guide portion, in order to provide improved rotational torque.

In one interesting embodiment, the microdevice may further comprise a plurality of nanowires, at least one nanowire being arranged for receiving electromagnetic radiation emitted from the first electromagnetic radiation emitting unit and emitting electromagnetic radiation onto the associated object, optionally at least one nanowire further being optically arranged for receiving electromagnetic radiation from an associated object (could be identical, or different from, to the object whereupon radiation is emitted onto) transmit it to the first electromagnetic radiation emitting unit. Alternatively, optionally one nanowire could be arranged for receiving electromagnetic radiation emitted from the first electromagnetic radiation emitting unit and emitting electromagnetic radiation, and at least one nanowire further being optically arranged for receiving electromagnetic radiation and transmit it to the first electromagnetic radiation emitting unit. Thus, various configurations for receiving and emitting EMR with a plurality of nanowires are contemplated within the general principle and teaching of the present invention.

It may be understood that the microdevice for emitting EMR onto an associated object may in an embodiment also be suitable for receiving electromagnetic radiation from the associated object, where the first electromagnetic radiation emitting unit may also function as a first electromagnetic radiation receiving unit arranged to receive and further transmit electromagnetic radiation, and wherein the nanowire is being also arranged for receiving said electromagnetic radiation from the associated object, and transmitting the electromagnetic radiation to the first electromagnetic radiation receiving unit.

In a second aspect, the present invention relates a microdevice for receiving electromagnetic radiation from an associated object, the microdevice comprising
a first electromagnetic radiation receiving unit arranged to receive and further transmit electromagnetic radiation, and
means for enabling simultaneous non-contact spatial control over the microdevice in terms of:
   translational movement in three dimensions, and
   rotational movement around at least two axes, preferably three axes,
      wherein the means for enabling non-contact spatial control over the microdevice are arranged for being spatially controlled by forces applied by electromagnetic radiation,
      wherein the first electromagnetic radiation receiving unit and the means for enabling spatial control over the microdevice are structurally linked, and
      wherein the microdevice further comprises a nanowire being arranged for receiving said electromagnetic radiation from the associated object, and transmitting the electromagnetic radiation to the first electromagnetic radiation receiving unit.

The invention according to this second aspect may, from an optical point of view, be regarded as a reverse variant of the invention according to the first aspect, in so far as the invention according to the second aspect is capable of receiving light from an associated object, whereas the invention according to the first aspect is arranged for emitting light, or EMR, on an associated object (could be identical, or different from, to the object in the second aspect).

In a third aspect, the present invention relates to a system for emitting and/or receiving electromagnetic radiation onto and/or from an associated object, the system having a microdevice comprising:
a first electromagnetic radiation emitting and/or receiving unit, and
means for enabling simultaneous non-contact spatial control over the microdevice in terms of:
   translational movement in three dimensions, and
   rotational movement around at least two axes, preferably three axes,
      wherein the means for enabling non-contact spatial control over the microdevice are arranged for being spatially controlled by forces applied by electromagnetic radiation,
      wherein the first electromagnetic radiation emitting and/or receiving unit and the means for enabling spatial control over the microdevice are structurally linked, and
      wherein the microdevice further comprises a nanowire being arranged for emitting and/or receiving electromagnetic radiation received and/or emitted, respectively, from the first electromagnetic radiation emitting and/or receiving unit.

In an alternative formulation of the third aspect, there is presented a system for emitting and/or receiving electromagnetic radiation onto and/or from an associated object, the system having
a microdevice for emitting electromagnetic radiation onto an associated object according to the first aspect,
   and/or
a microdevice (100) for receiving electromagnetic radiation from an associated object according to the second aspect.

The system may further comprise:
a second electromagnetic radiation emitting unit being adapted to generate electromagnetic radiation for spatially controlling and thereby optically manipulating the microdevice for emitting electromagnetic radiation onto an associated object according to the first aspect and/or the microdevice for receiving electromagnetic radiation from an associated object according to the second aspect.

The system may further comprise:
an optical unit,
   wherein the optical unit is capable of
providing electromagnetic radiation for re-emission by the microdevice for emitting electromagnetic radiation onto an associated object according to the first aspect,
   and/or
receiving electromagnetic radiation, such as electromagnetic radiation from the microdevice for receiving electromagnetic radiation from an associated object according to the second aspect, such as electromagnetic radiation being representative of a property of the object, such as electromagnetic radiation being representative of an image of the object.

The system may further comprise:
a control unit (1003), such as a control unit having suitable control and monitoring means, such as computer software running on dedicated computers and visualisation.

The invention according to this aspect is particularly advantageous in providing an overall system for control and/or monitoring of an associated object, possible a plurality of objects, using one or more microdevices according to the first and/or second aspect.

In fourth aspect, the present invention relates to a corresponding method for emitting and/or receiving electromagnetic radiation onto and/or from an associated object using a microdevice according to the first and/or second aspect, the method comprising:
providing a first electromagnetic radiation emitting and/or receiving unit in the microdevice, and
enabling non-contact spatial control over the microdevice in terms of:
   translational movement in three dimensions, and
   rotational movement around at least two axes, preferably three axes,
      wherein the enabling of non-contact spatial control over the microdevice is provided by spatially control by forces of electromagnetic radiation, and wherein the microdevice further comprises a nanowire being arranged for emitting and/or receiving electromagnetic radiation received and/or emitted, respectively, from the first electromagnetic radiation emitting and/or receiving unit.

The individual aspects of the present invention may each be combined with any of the other aspects. These and other aspects of the invention will be apparent from the following description with reference to the described embodiments.

### BRIEF DESCRIPTION OF THE FIGURES

The microdevice according to the invention will now be described in more detail with regard to the accompanying figures. The figures show one way of implementing the present invention and is not to be construed as being limiting to other possible embodiments falling within the scope of the attached claim set.

FIG. 1 shows a perspective view of a microdevice comprising a nanowire,

FIG. 2 shows a side view of the microdevice comprising a nanowire corresponding to the view in FIG. 1,

FIGS. 3 and 4 show schematic side views of nanowire and the part of the microdevice adjacent to the nanowire,

FIG. 5 shows a perspective view of a microdevice comprising a nanowire, the microdevice having tapered structure with a metal coating,

FIG. 6 shows a side view of the microdevice comprising a nanowire corresponding to the view in FIG. 5, the microdevice having tapered structure with a metal coating,

FIG. 7 shows a perspective view of a microdevice comprising a plurality of nanowires,

FIG. 8A shows a perspective view of another microdevice comprising a plurality of nanowires pointing in different directions,

FIG. 8B shows a top view of a microdevice comprising a plurality of nanowires, the different nanowires having separate light in-coupling and/or out-coupling elements,

FIG. 9 shows a perspective view of a microdevice with a conical shape having a single nanowire in the upper part, and in the lower part a bottom view of the same microdevice,

FIG. 10 schematically shows a system for emitting electromagnetic radiation onto an associated object, and

FIG. 11 a schematic flow chart representing an outline of a method according to the present invention.

### DETAILED DESCRIPTION OF AN EMBODIMENT

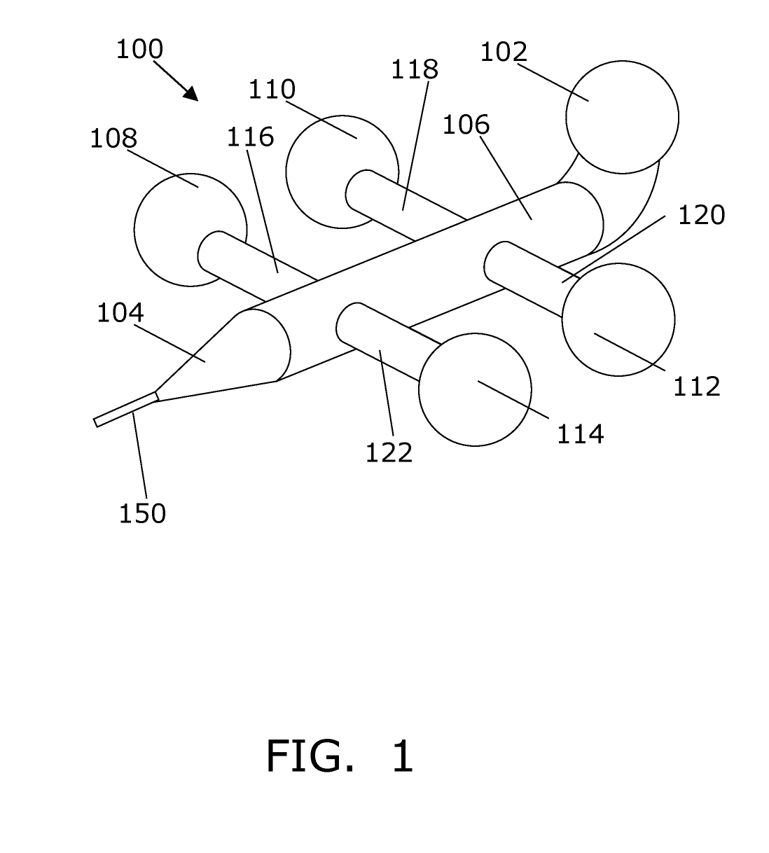

In the following section, light is used interchangeably with EMR. It is understood that light may be used in particular embodiments, but that the exemplary use of light in those embodiments do not constrain the invention to use of light only. FIG. 1 shows a perspective view of a microdevice 100 according to an embodiment of the invention, the microdevice 100 features a light in-coupling element 102, a light out-coupling element 104, and nanowire 150 being arranged for receiving electromagnetic radiation emitted from the first electromagnetic radiation emitting unit 102 and emitting electromagnetic radiation through the microdevice body towards the nanowire 150. The relative size of the nanowire with respect to the microdevice is not to scale. The light in-coupling element 102 is arranged to receive light and guide the received light into a light guiding element 106 which optically connects the light in-coupling element with the light out-coupling element. Thus, light may be received at light guiding element 102 and guided by light guiding element 106 to the light out-coupling element 104 where it is emitted via the nanowire 150. The optical elements 102, 104, and 106 may form a first electromagnetic radiation emitting unit arranged to emit electromagnetic radiation. The optical elements 102, 104, 106 and 150 thus further forms an EMR emitting unit, or microdevice, which enables emission of EMR, such as light.

The microdevice 100 further comprises means for enabling non-contact spatial control over the microdevice, the means being embodied by optical handles 108, 110, 112, 114. Each of the optical handles is structurally linked to the light guiding element 106 via linking structures 116, 118, 120, 122. In the present embodiment, the light out-coupling element 104 is conically shaped, an advantage of such shape may be that the microdevice thus has a sharp tip which may be designed for optimum structural and/or optical connection to the attached nanowire 150. Another advantage may be that the light out-coupling element may serve as an output element for shaping the EMR guided towards the nanowire 150 from the first EMR emitting unit.

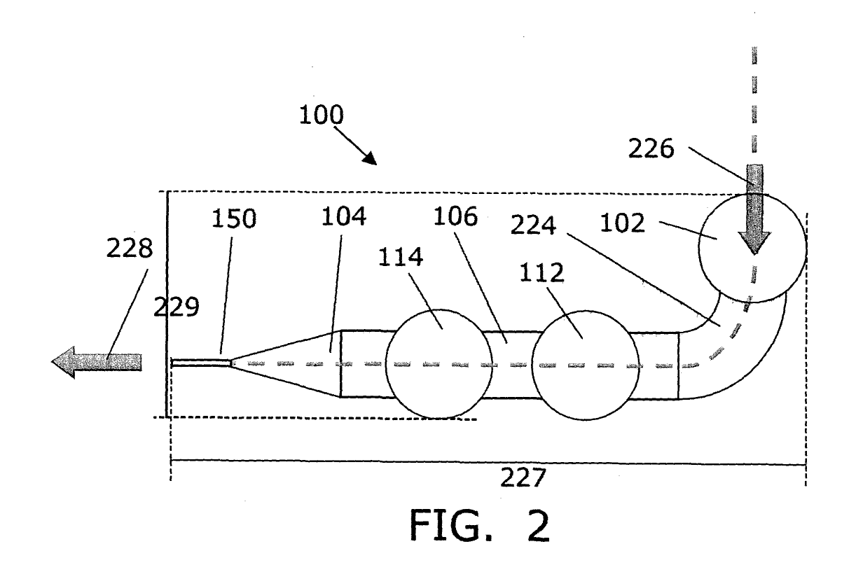

FIG. 2 shows a side view of the microdevice 100 depicted in FIG. 1. In FIG. 2, a bend part 224 of the light guiding element 106 is more clearly seen. The bend part 224 of the light guiding element enables incoming light 226 to be received by the light in-coupling element 102 and to be guided through the light guiding element 106 and through the light out-coupling part 104 via the nanowire 150 as emitted light 228. The skilled person will readily realize that the optical path is bi-directional, and light may consequently also be collected at the light out-coupling element 104, be guided through the light guiding element 106 and emitted from the light in-coupling element 102. FIG. 2 also indicates a length 227 and a height 229 of the microdevice.

In an exemplary embodiment the length 227 is 35 micrometer and the height 229 is 20 micrometer, but other dimensions in the micrometer region, such as within 1 micrometer to 1 millimeter are conceivable.

In an exemplary embodiment, the length of the nanowire can be in the interval from 10 to 10000 nm (nanometer), typically 3-4 micrometers, more alternatively in the interval from 50 to 1500 nm, even more alternatively in the interval from 100 to 800 nm. Alternatively, the length of the nanowire may be limited from below (i.e. a minimum value) by any of the preceding interval limits (upper and lower), or more alternatively, the length of the nanowire may be limited from above (i.e. a maximum value) by any of the preceding interval limits (upper and/or lower).

In an exemplary embodiment, the width of the nanowire can be in the interval from 1 to 500 nm (nanometer), typically 10-20 nanometers, more alternatively in the interval from 10 to 400 nm, more alternatively in the interval from 30 to 300 nm. Alternatively, the width of the nanowire may be limited from below (i.e. a minimum value) by any of the preceding interval limits (upper and lower), or more alternatively, the width of the nanowire may be limited from above (i.e. a maximum value) by any of the preceding interval limits (upper and/or lower).

In the above embodiments, it is understood by the skilled person that typically a nanowire may be non-exhaustively defined to be an elongated body, where the concept of width and/or length makes technical meaning, at least from a general perspective with respect to an average or an approximate outer measure characterizing the nanowire according to the present invention.

### Fabrication

The microdevice of FIGS. 1-2 is fabricated by using the two-photon microfabrication system described in Rodrigo et al., “Optical microassembly platform for constructing reconfigurable microenvironments for biomedical studies,” Optics Express 17, 6578-6583 (2009), which is hereby incorporated by reference in its entirety. The procedure includes a two-minute soft bake of spin-coated photoresist layer (SU8 2007, Microchem) before laser illumination and a 10 minutes post bake after the illumination, both at 95° C. on a hot plate. Microstructures were formed by scanning tightly focused ultrashort pulses from a Ti:sapphire laser (λ=796 nm, 100 fs pulses, 80 MHz repetition rate, 3 mW average power) in the photoresist. The laser pulses were focused by an oil-immersion microscope objective (100×Zeiss Achroplan, 1.25 NA objective; DF-type immersion oil Cargille Laboratories, formula code 1261, n=1.515). The focal spot was scanned relative to the resin at speeds of 10 μm/s for the spheres and 5 μm/s for the connecting rods and tip to solidify voxels with minimum transverse and axial feature sizes of 0.4±0.1 μm in transverse and 1±0.1 μm in longitudinal directions, respectively. A sample design file may be used for specifying the laser path and dimensions for a given microdevice. An exemplary microdevice may have dimensions of 35 μm×20 μm×6 μm (corresponding to length×width×height) and having spherical handles 6 μm in diameter.

The nanowire can be manufactured in connection with the microdevice in essentially two different ways;
1. By the same (or modified) process: Thus, the microdevice is manufactured e.g. by two-photon microfabrication (as described above) where the core or bulk of the microdevice is structurally and optically connected to the nanowire. This is obtainable because state of the art two-photon microfabrication has already reached a resolution around 25 nm facilitating such a combined process where the microdevice has a nanowire portion, typically manufactured in the same material. The nanowire may be manufactured in another material relative to remaining part of the microdevice if the photoresist layer is locally changed where the nanowire is to be produced.
   An example of a fabrication method includes a gold nanowire/polymer composite microdevice. The principle of this process would be based on a combination of locally initiated two-photon polymerization (2PP) at the surface of a gold nanowire and optical gradient forces acting at the laser focus spot by means of femto-second near-infrared laser light. When the laser light is tightly focused into the gold nanowire/polymer resin compound, a nanowire will inherently be attracted towards the laser spot by the induced optical gradient forces. Simultaneously, excited local surface plasmons can lead to the initiation of a 2PP process only at the nanowire surface and automatically form a connection resulting in the creation of a composite microdevice having a nanowire optically and structurally connected thereto.
Another example of fabrication process includes a microdevice comprising a Single Walled NanoTube (SWNT) and a polymer composite by means of two photon polymerization lithography. SWNTs can be dispersed in an acrylate monomer by sonication, and a small amount of photoinitiator and photosensitizer can be loaded into the mixture. The SWNT-dispersed photo resin should be casted on a glass substrate. A femto-second laser can photopolymerize a nanometric volume of the resin and a microdevice according to the present invention using a SWNT can be created.

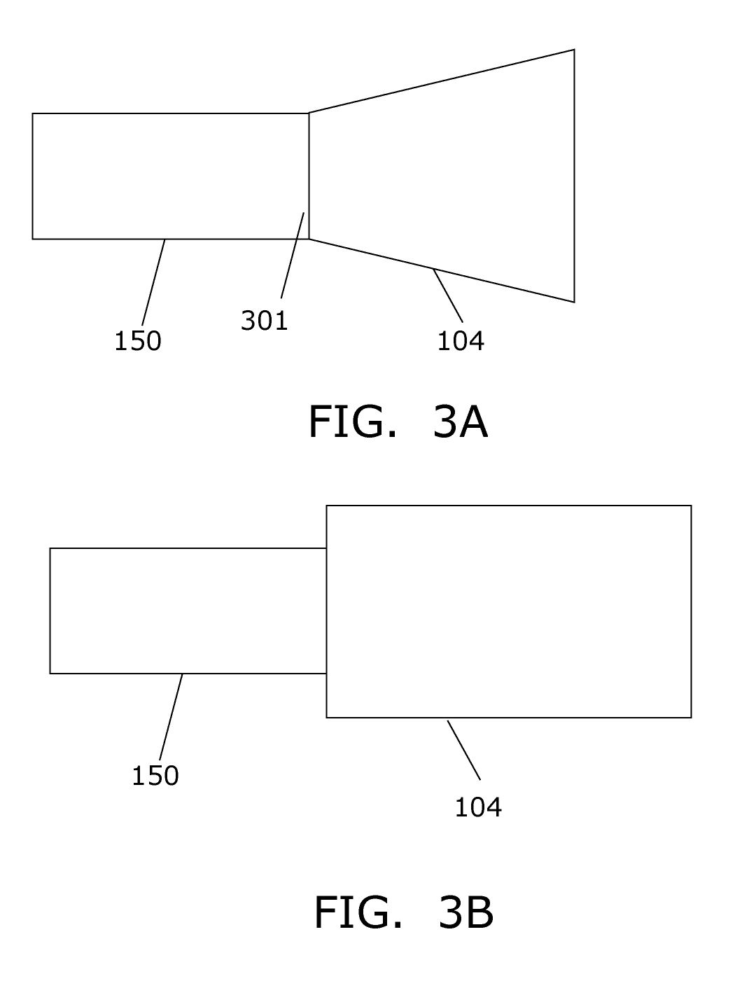

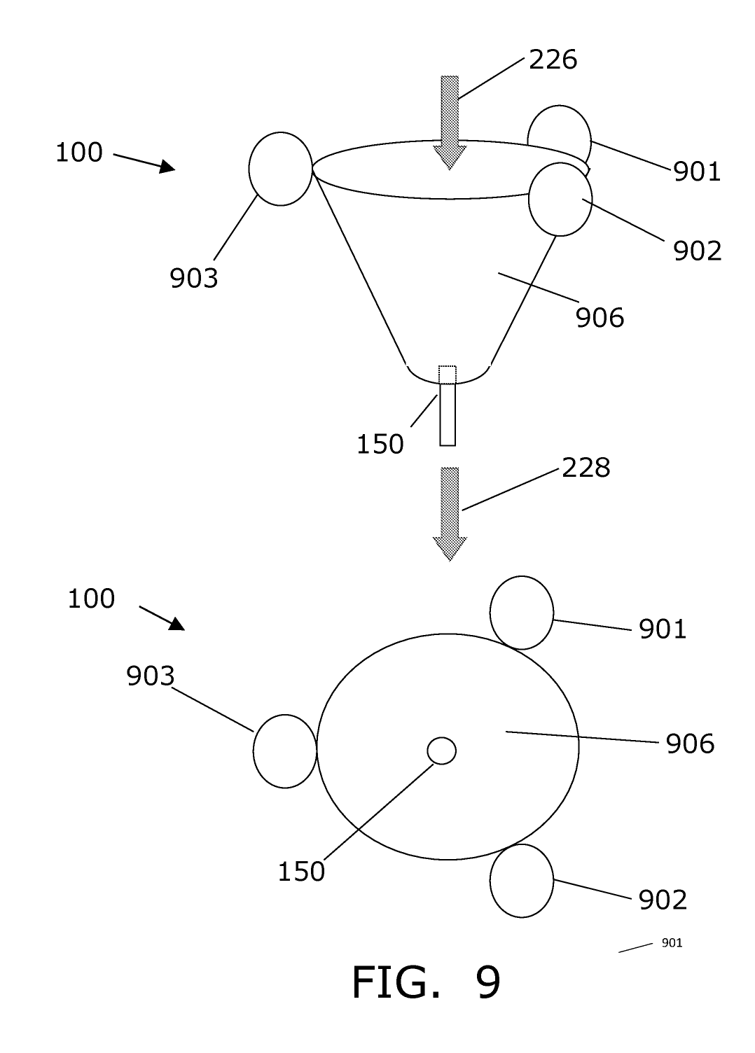

Another example of a fabrication process for attaching a nanowire to an optically controllable device is given in the article “3D Fabrication and Manipulation of Hybrid Nanorobots by Laser” (IEEE International Conference on Robotics and Automation (ICRA), 2013, 6-10 May 2013, Pages: 2594-2599) by Shota Fukada, et al., which is published after the priority date of the present application, and which is hereby incorporated by reference in entirety. In particular, reference is made to the section “III. FABRICATION PROCESS OF NANOROBOT” on page 2595 incl. FIG. 3 on page 2596 which is hereby incorporated by reference, and furthermore the section “IV. FABRICATION AND MANIPULATION OF NANOROBOT” on pages 2596-2597 which is hereby incorporated by reference. It may be understood, that while the article employs silicon nanowires, the present invention may employ nanowires of other materials, such as the material of the nanowire being a single material, such as a metal (e.g. Ag, Au), semiconductor (e.g. GaN), polymer, silica, nonlinear crystal (e.g. ZnO, KnbO₃), biofriendly SnO₂, graphene, etc., or the nanowire can be suitably manufactured in a composite material having several appropriate materials for providing an overall desirable optically working nanowire (e.g., the nanowire may be manufactured with an inner core of one material, e.g. glass, and one or outer materials, preferably arranged in a peripheral manner with respect to the inner core, to more complete or particular reflection on the edges of the nanowire. In a specific embodiment, the nanowire may be metal coated (e.g. silver or gold) so as to include possible surface plasmons coupled with photons to yield i.e. surface plasmon polaritons (SPPs) to be utilised in the context of the present invention) and that the material of the nanowire may be chosen to be different within the context of the present invention with respect to the silicon nanowires of the article.
2. In two separate processes: The microdevice without the nanowire may be manufactured by e.g. the (above described) two-photon microfabrication and subsequently the nanowire is attached to the microdevice so as to structurally and optically connect the nanowire to the microdevice according to the present invention. This has the advantage that the nanowire can be manufactured in a completely different process (giving a wider choice of materials and structural and optical designs) and then connected to the remaining part of the microdevice. The nanowire can be optically manipulated in space and positioned adjacent to the microdevice. Subsequently, the nanowire can be attached onto the microdevice, e.g. by laser fusing or welding. Nano-welding using e.g. a sacrificial metal layer or cold welding may be advantageous ways of joining the nanowire. An example could be to apply the technique published by Nakayama et al. in Nature, 447, 28 Jun. 2007, using a photorefractive KNbO₃ nanowire that is optically trapped and subsequently inserted onto a prefabricated microdevice. A proper wavelength can subsequently fuse the two parts into a single microdevice with a nanowire. This will be explained in more detail in connection with FIG. 9 below.

### Sample Preparation

After developing and harvesting the microdevices, they may be stored in a solvent containing a mixture of 0.5% surfactant (Tween 20) and 0.05% azide in water. The surfactant prevents the microdevices from sticking to each other and to the sample chamber; the azide prevents microbial growth during storage. To use the microdevices, the sample is centrifuged to let the microdevices settle to the bottom for easier collection. For the light coupling experiments, the microdevices are first mixed with a fluorescent solvent (calcium orange diluted with ethanol) before loading into the cytometry cell).

### Optical Micromanipulation

The so-called BioPhotonics Workstation can be used for optical trapping and manipulation of fabricated microdevices. The BioPhotonics Workstation is described in the reference “Independent trapping, manipulation and characterization by an all-optical biophotonics workstation”, by H. U. Ulriksen et al., J. Europ. Opt. Soc. Rap. Public. 3, 08034 (2008), which is hereby incorporated by reference in its entirety. The BioPhotonics Workstation uses near-infrared light (λ=1064 nm) from a fibre laser. Real-time spatial addressing of the expanded laser source in the beam modulation module produces reconfigurable intensity patterns. Optical mapping two independently addressable regions in a computer-controlled spatial light modulator as counterpropagating beams in the sample volume enables trapping a plurality of micro-objects (currently generates up to 100 optical traps). The beams are relayed through opposite microscope objectives (Olympus LMPLN 50×IR, WD=6.0 mm, NA=0.55) into a 4.2 mm thick Hellma cell (250 μm×250 μm inner cross section). A user traps and steers the desired object(s) in three dimensions through a computer interface where the operator can select, trap, move and reorient cells and fabricated microdevices with a mouse or joystick in real-time. Videos of the experiments are grabbed simultaneously from the top-view and side-view microscopes. It is also contemplated that other means than the BioPhotonics Workstation may be used together with the present invention in order to spatially control microdevices, such as optical tweezers, such as scanning optical tweezers, such as holographic optical tweezers (see the reference “Holographic optical tweezers and their relevance to lab on chip devices”, M. Padgett and R. Leonardo, Lab Chip 11, 1196, (2011), which is hereby incorporated by reference in its entirety), such as dielectrophoresis.

The skilled reader is also referred to the reference “Wave-guided optical waveguides” by Palima et al. (incl. the present inventor), Optics Express 20, 2004-2014, (2012) which is hereby incorporated by reference in its entirety, for an introduction of optically manipulated microdevices similar to the present invention, though without the advantageous nanowire being structurally and optically connected to the microdevices having new and surprising optical purposes. The skilled reader is also referred to international patent application WO 2012/155919 (inventors Darwin Palima and Jesper Glückstad, the present inventor), which is also hereby incorporated by reference in its entirety, for further details regarding optically manipulating and manufacturing of microdevices similar to the present invention, but also without a nanowire.

Also it should be mentioned that it is possible to perform a so-called “light impedance matching” of a microdevice and a merged nanowire according to the principle and teaching of the present invention. Using fundamental thermal and electronic processes of refractive index modifications induced by femtosecond laser radiation focused in the volume of e.g. a glass material or polymer material of the microdevice. Adjusting the dependency of the temporal sequence of laser pulses on the induced refractive index change can be enabled by for example a low and high repetition rate laser pulses as well as by use of laser double pulses with a varied time distance in the picosecond regime. The basis for the control of these induced refractive index changes in a microdevice can enable gradient index variations that can be gradually matched to an attached or inserted nanowire, and thus effectively create a gradient refractive index profile that change, e.g. increases, in the direction towards the nanowire joining point to provide an optimum optical interface between the microdevice and the nanowire.

In order to design the microdevice with the nanowire in the best possible way from an optical perspective, it is important that at least two new critical light-interfaces are to be considered in the overall design.

The first interface is occurring in the transition from the microdevice to the attached or inserted nanowire 150. The second light-interface is occurring from the nanowire to the surrounding medium.

Notice in particular, that for many biological or medical applications the surrounding medium may be a physiological relevant fluid having a refractive index, e.g. around 1.3-1.4.

Many factors influence the light transfer (or light-conversion in case of nonlinear nanowire crystals) capability and in general advanced 3D fully vectorial numerical techniques are required to optimise these interfaces, e.g. by design the familiar tapering transition where one or more interfaces are gradually increasing and/or decreasing in the transverse width (e.g. diameter) in order to provide the optimum interface.

Factors that influence are e.g. different refractive indices on the interfaces, the nanowire dimensions (width and length), nanowire composition, nanowire tapering (e.g. conical, flat, or combined conical/flat end), tapering angles of both microdevice, in particular the out-coupling element 104, and nanowire at both interfaces etc. Other factors will be readily appreciated by the skilled person once the general principle and teaching of the present invention has been fully comprehended.

FIGS. 3 and 4 show schematic side views of nanowire and the part of the microdevice adjacent to the nanowire and some exemplary embodiments of the possible tapering of the microdevice, e.g. particular the out-coupling element 104, and/or the nanowire 150.

In FIG. 3A, only the out-coupling element 104 has a tapered structure as indicated, and the nanowire 150 has (substantially) the same width along the length i.e. no tapered structure. This is similar to the embodiment shown in FIGS. 1 and 2. In this embodiment, the interface 301 between the nanowire 150 and out-coupling element 104 (forming part of the microdevice 100) is seen to have the same width where the two elements are structurally connected i.e. joined together.

In FIG. 3B, there is no tapered structure of neither the out-coupling element 104 nor the nanowire 150. This does not exclude that the microdevice 100, especially a light guiding section 106, has a width being larger relative to the out-coupling element 104. The width of the nanowire 150 can be larger, (substantially) equal, or smaller (as shown) than the width of the out-coupling element 104.

In FIG. 4A, the out-coupling element 104 has a non-tapered structure as indicated, and the nanowire 150 has a tapered structure along the length i.e. the wider end being adjacent to the element 104 of the microdevice. Notice that the tapered structure of the nanowire 150 in this embodiment, and the embodiment of FIG. 4B, could alternatively have a tapered structure where the narrow end was adjacent, and attached to and/or inserted in, to the element 104 (not shown). In a further variant of this embodiment, the nanowire could have portions that have differently tapered shape e.g. different inclination angles and/or directions of tapering (e.g. wobbling shape along the length).

In FIG. 4B, both the out-coupling element 104 has a tapered structure as indicated, as well as the nanowire 150 has a tapered structure. In the embodiment shown, the angle of inclination is schematically indicated to be approximately the same angle, but different angles are also contemplated and may be readily realized.

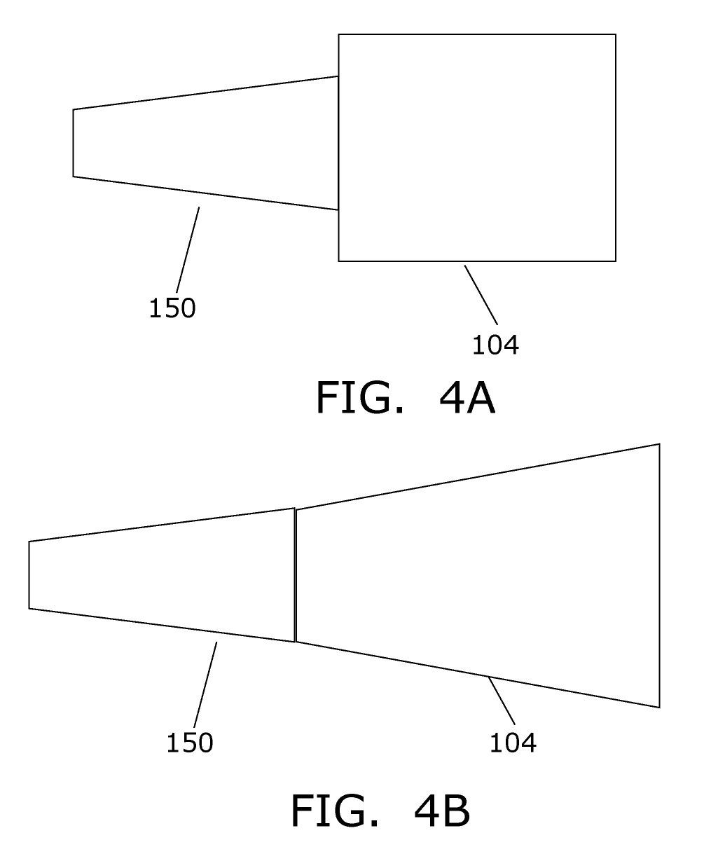

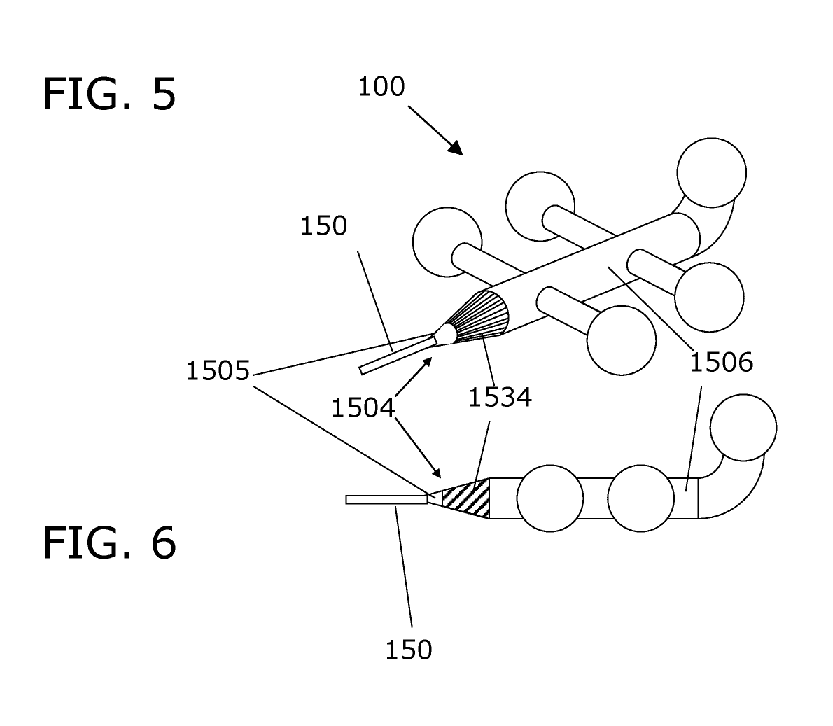

FIGS. 5-6 show, respectively, a perspective view and a side view similar to FIGS. 1-2. In FIGS. 5-6 the conical light out-coupling element 1504 is partially coated with a non-transparent coating 1534, e.g. a metal coating, where only the tip 1505 of the conical structure is left uncoated. An advantage of this may be that the EMR propagating through the light guiding element 1506 in a direction towards the conical out-coupling element 1504 and further to the nanowire 150 may be confined spatially beyond the diffraction limit.

A similar principle is used in Scanning Near Field Optical Microscopes (SNOMs) where a sub-wavelength aperture (which in the present embodiment corresponds to the small aperture in the coating 1534 in the end with the nanowire tapering 1505) enables imaging or probing areas smaller than the diffraction limit.

In a particular embodiment, the light guiding element 1506 and the conical light out-coupling element 1504 may be of a fractal fibre structure where the internal structure of the conical out-coupling element scales with the outer diameter. This may be advantageous for further confining the propagating mode spatially. The principle of fractal fibres is described in the scientific article “A fractal-based fibre for ultra-high throughput optical probes”, S. T. Huntington et al., Optics Express, March 2007, Vol. 15, No. 5, 2468, which is hereby incorporated by reference in entirety. It is also encompassed by the invention that the light guiding element 1506 has a square-core optical fiber. Square-core optical fibers are described in “Square fibers solve multiple application challenges”, Franz Schberts et al., Photonics Spectra, Vol. 45, 2, p. 38-41, which is hereby incorporated by reference in its entirety.

It is also encompassed by teaching of the present invention to use other means for confining the propagating mode spatially beyond the diffraction limit, for example by using plasmonics as is described in the scientific article “Plasmonics beyond the diffraction limit”, by D. K. Gramotnev and S. I. Bozhevolnyi, Nature Photonics 4, 83-91, 2010, which is hereby incorporated by reference in its entirety, and particular attention is drawn to the section entitled “Plasmon nanofocusing” p. 85-86.

There is an important issue in the synthesising of a tailored 3D light confinement at the tip of a microdevice comprising a nanowire optically connected to the microdevice. By a careful optical design, e.g. suitable tapering as described above, of the nanowire and the out coupling element 104 in terms of a specific conical angle and using a flat end face, it is possible to confine light in a very narrow volume for optimal probing of nanometer-scale constituents.

The microdevice comprising a nanowire optically connected to the microdevice can further act as a light coupling unit to the nanowire. It may also act as a vehicle for full and real-time 3D, 6DOF displacement control.

When lasing is desired in the nanowire, the structure of the microdevice effectively acts as provider of a pump source. Using e.g. a double-facet GaN nanowire 150, functioning as both gain medium and optical resonator, single mode nanowire lasing can be achieved, as it will be appreciated by the skilled person once the general principle and teaching of the present invention has been fully comprehended.

To achieve singlemode operation, it is important to reduce the number of cavity modes within the gain bandwidth. This requires significant reduction and precise control of the nanowire dimensions, as well as a high material gain necessary to compensate for a reduced gain length if lasing is desired. This can be achieved by using a top-down technique that exploits a tunable dry etch plus an anisotropic wet etch. Multimode laser theory can be used to show that single-mode lasing arises from strong mode competition and narrow gain bandwidth.

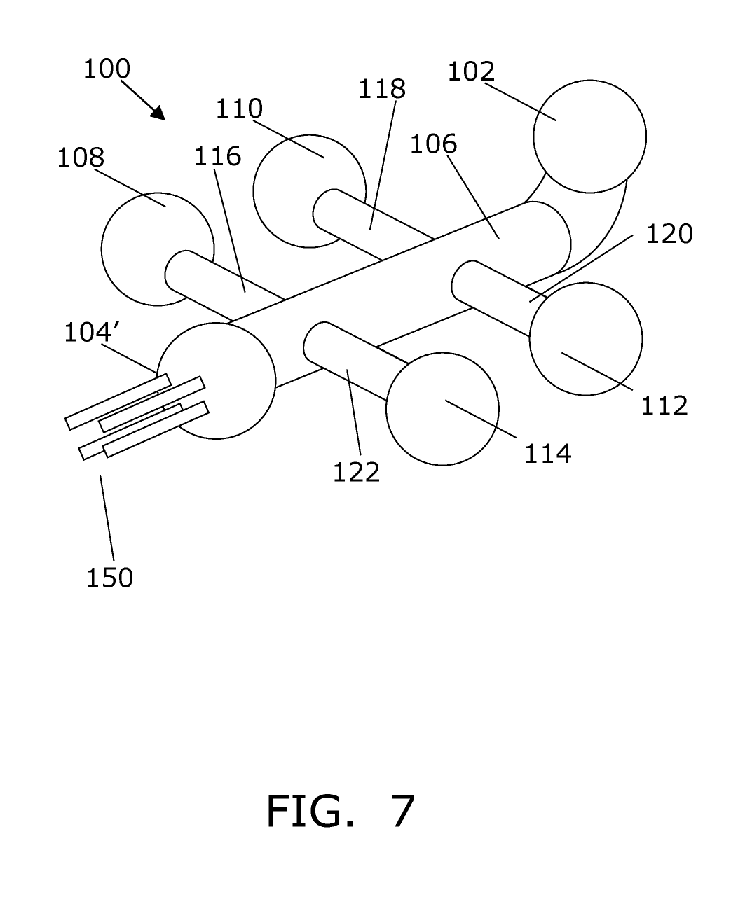

FIG. 7 shows a perspective view of a microdevice comprising a plurality of nanowires 150 similar to the embodiment shown in FIGS. 1-2, except that the EMR out-coupling element 104′ in the embodiment of the present figure has a round shape. This in turn may facilitate a plurality of nanowires to be attached to, and/or inserted into, the microdevice 100. In the embodiment shown, 4 nanowires are shown but this is purely for illustrative purposes only. The number of nanowires 150 may enlarge the imaging capability and/or the radiation capability of the microdevice. The plurality of nanowires 150 shown in this embodiment are shown to be approximately or substantially parallel, but they may also be non-parallel e.g. having a common both of focus for imaging and/or irradiation purposes as will readily be understood by a person skilled in optics.

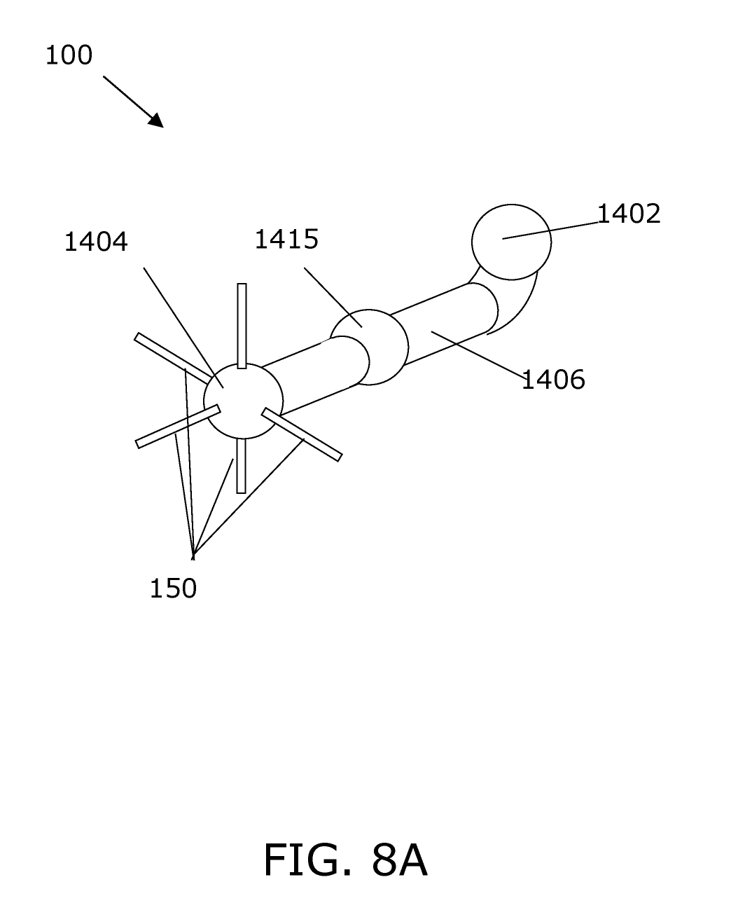

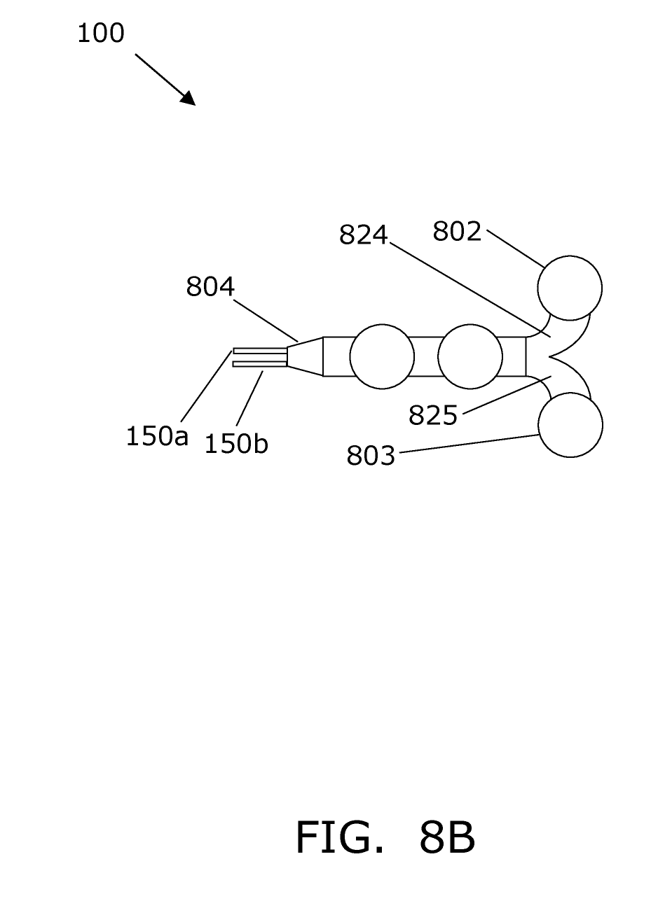

FIG. 8A shows a perspective view of a microdevice similarly comprising a plurality of nanowires 150. In the embodiment shown, 5 nanowires are shown but this is purely for illustrative purposes only. There may be 2, 3, 4, 5, 6, 8, 9, 10, 20, 30, 40, 50, 60, 70, 80, 90, 100 or more nanowires attached onto the microdevice 100. FIG. 8A is similar to FIG. 1 except that the EMR out-coupling element in the embodiment of the present figure has a round shape and that the linking structures with their optical handles have been removed, and instead an optical handle 1415 has been placed directly around the light guiding element 1406. Notice that this embodiment could also be implemented with linking structures requiring no other substantial modification of the microdevice. In the present embodiment however, the spherical EMR in-coupling element 1402 and the spherical EMR out-coupling element 1404 may also each function as an optical handle. The nanowires 150 each point in spatially different directions and may optionally function in a bidirectional optical mode of both receiving and transmitting light, in particular if the microdevice is used as an optical investigation vehicle, this configuration may be advantageous by providing a relatively large solid angle of imaging in e.g. an unknown environment.

FIG. 8B shows a side view of an embodiment according to the invention, which is similar to the embodiment shown in FIG. 2 except that the particular embodiment of FIG. 8B has two in-coupling elements 802, 803 and correspondingly two bend parts 824, 825 of the light guiding elements. In this particular embodiment, both in-coupling elements 802, 803 are coupled to the same EMR out-coupling element 804 having two nanowires 150a and 150b as shown. FIG. 8B shows 2 nanowire 150a and 150b, and the different nanowires may be having separate light in-coupling and/or out-coupling elements shown as elements 802 and 803, respectively. Thus, the optical path connecting nanowire 150a and element 802 may be different from the optical path connecting nanowire 150b and element 803. In other embodiments, an in-coupling element may further be sub-divided so as to facilitate multiple optical paths connected to separate nanowires. In other embodiments, the separation between the radiation resulting from the various nanowires can be performed by multiplexing so that the same optical path may be used, at least partly.

FIG. 9 shows a perspective view of microdevice 100 with a substantially conical shape having a single nanowire 150 attached on the narrow end of the conical shape, which functions as out-coupling element to the nanowire. The wider end of the conical shape functions as in-coupling element for the light guiding element 906 which enables incoming light 226 to be received and to be guided through the light guiding element and through the light out-coupling part of the cone 904 via the nanowire 150 as emitted light 228. Handling elements 901, 902, and 903 for non-contact spatial control of the device 100 are also shown. In the lower part of FIG. 9, a bottom view of the same microdevice 100 is shown.

The conical shape shown in FIG. 9 can alternatively be tapered near the optical interface to the nanowire, e.g. by having a more narrow portion near the nanowire (not shown) like an inwardly curved funnel. Alternatively, the microdevice may have the shape of an outwardly curved funnel. The shape of the microdevice 100 can alternatively be a disc-like shape with light entering from one side of the disc and exiting on the other side of the disc-like shape (also not shown).

This embodiment is particularly suited to be manufactured with a ceramic nanowire, e.g. KNbO₃ nanowire being manipulated in a laser trap as for example described by Yuri Nakayama et al. in Nature, 447, 28 Jun. 2007, which is hereby incorporated by reference in its entirety. The same laser trap may also be applied to manufacture and/or manipulate the microdevice without the nanowire, and subsequently the nanowire can be structurally and optically joined with the microdevice 100 using laser fusing of the adjoining surfaces by an appropriate laser source (power, wavelength) taking into account inter alia the different materials and the desired properties of the optical interface.

Notice that in this embodiment, the incoming light 226 can be parallel to the emitted light 228. In particular, the nanowire 150 may facilitate non-linear optical phenomena, such as frequency doubling or upconversion, with the incoming light 226 so that the emitted radiation or light 228 is optically modulated by the microdevice due to the inherent optical properties of the nanowire 150.

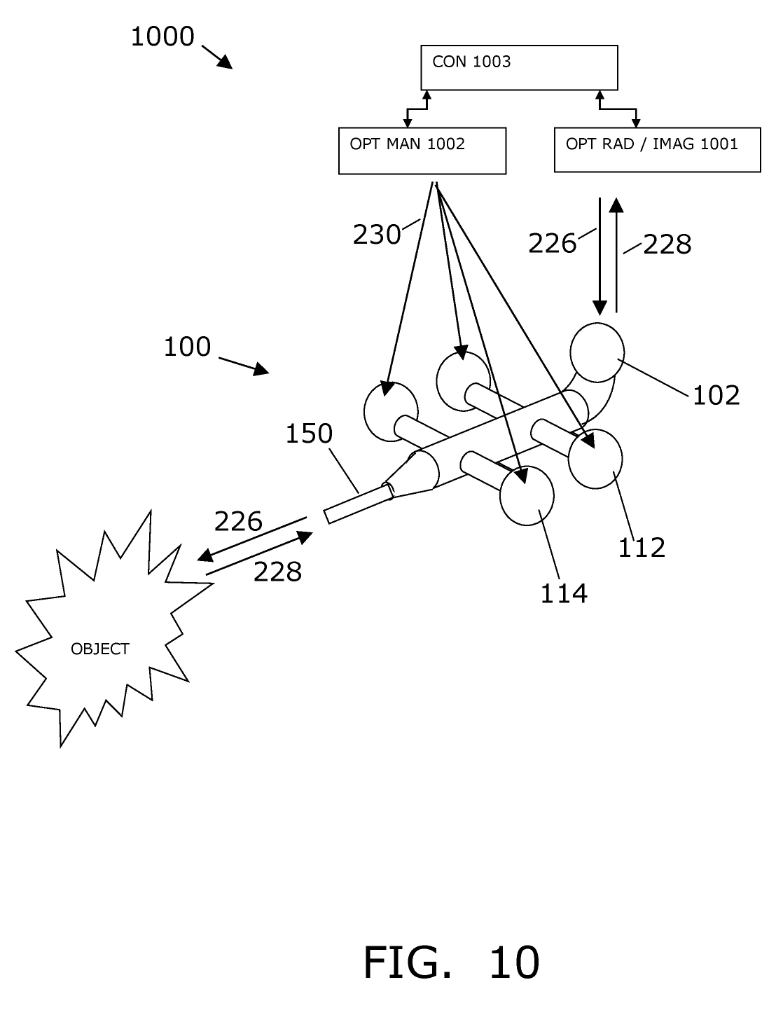

FIG. 10 schematically shows a system 1000 for emitting electromagnetic radiation 226 onto an associated object (‘OBJECT’ in FIG. 10) using a microdevice 100 specifically comprising a nanowire 150. Alternatively or additionally, the system 1000 can be used for receiving electromagnetic radiation 228 from an associated object.

The system 1000 is thus capable of emitting EMR 226 onto an associated object, e.g. by a radiation unit such as a laser 1001, the system comprising:
a microdevice 100 for emitting EMR 226, the EMR 226 being originally emitted, or optically powered, by the optical unit 1001 OPT RAD/IMAG capable of providing such radiation, alternatively or additionally, the unit 1001 is capable of receiving radiation EMR 228 representative of e.g. image(s) of the object, and
a second EMR emitting unit 1002 OPT MAN being adapted to generate the EMR 230 for spatially controlling and thereby optically manipulating the microdevice 100.

Both the optical unit 1001 OPT RAD/IMAG and the second EMR emitting unit 1002 OPT MAN can be controlled and monitored, as indicated by the double-arrows, by control unit 1003 CON having suitable control and monitoring means, e.g. computer software running on dedicated computers and visualisation means.

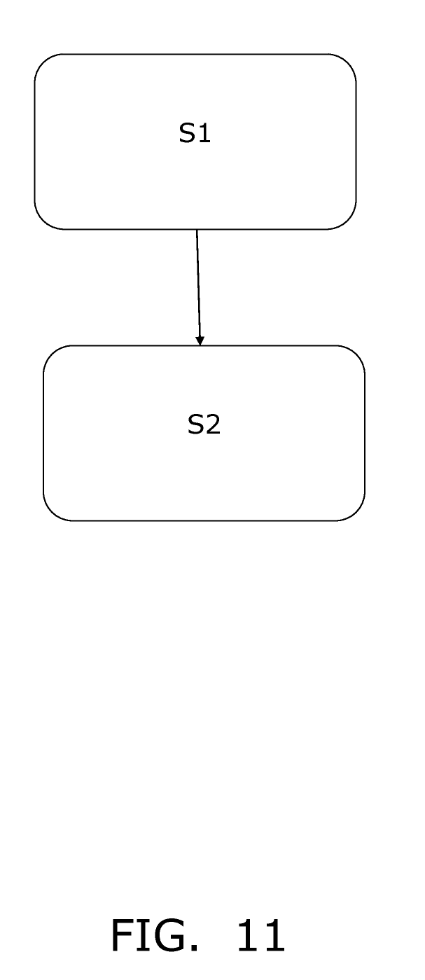

FIG. 11 shows a schematic flow chart representing a method according to the present invention for emitting and/or receiving electromagnetic radiation onto 226 and/or from 228 an associated OBJECT using the microdevice 100, the method comprising:

S1 providing a first electromagnetic radiation emitting and/or receiving unit 102, 104, and 106 in the microdevice, and
S2 enabling non-contact spatial control over the microdevice 100 in terms of:
translational movement in three dimensions, and
rotational movement around at least two axes, preferably three axes,
   wherein the enabling of non-contact spatial control over the microdevice is provided by spatially control by forces of electromagnetic radiation 230, and wherein the microdevice further comprises a nanowire 150 being arranged for emitting 226 and/or receiving 228 electromagnetic radiation received and/or emitted, respectively, from the first electromagnetic radiation emitting and/or receiving unit.

In short, the present invention relates to a microdevice for emitting electromagnetic radiation onto an associated object. Simultaneous non-contact spatial control over the microdevice in terms of translational movement in three dimensions, and rotational movement around at least two axes, preferably three axes, is possible. The microdevice further comprises a nanowire being arranged for emitting electromagnetic radiation onto said associated object. This is advantageous for obtaining better spatial control of the microdevice comprising the nanowire, and this enables that light could more effectively be coupled into the nanowire. This opens up for a much wider application of nanowires in optics because of the improved spatial control.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

In exemplary embodiments there is provided:

E1. A microdevice (100) for emitting electromagnetic radiation onto an associated object, the microdevice comprising
a first electromagnetic radiation emitting unit arranged to emit electromagnetic radiation, and
means for enabling simultaneous non-contact spatial control over the microdevice in terms of:
   translational movement in three dimensions, and
   rotational movement around at least two axes, preferably three axes,
      wherein the means for enabling non-contact spatial control over the microdevice are arranged for being spatially controlled by forces applied by electromagnetic radiation,
      wherein the first electromagnetic radiation emitting unit and the means for enabling spatial control over the microdevice are structurally linked, and wherein the microdevice further comprises a nanowire being arranged for receiving electromagnetic radiation emitted from the first electromagnetic radiation emitting unit and emitting electromagnetic radiation onto said associated object.

E2. The microdevice (100) for emitting electromagnetic radiation according to embodiment E1, the first electromagnetic radiation emitting unit comprising:
an electromagnetic radiation in-coupling element (102) arranged to receive incoming electromagnetic radiation, and
an electromagnetic radiation out-coupling (104) element being structurally linked to the electromagnetic radiation in-coupling element and the electromagnetic radiation out-coupling element being arranged to emit electromagnetic radiation in response to said incoming electromagnetic radiation,
   wherein the electromagnetic radiation out-coupling (104) element is structurally and optically connected to said nanowire for emitting electromagnetic radiation.

E3. The microdevice (100) for emitting electromagnetic radiation according to embodiment E2, wherein the electromagnetic radiation out-coupling (104) element is structurally and optically connected to said nanowire for emitting electromagnetic radiation, the nanowire further being optically and structurally arranged for performing lasing with an appropriate incoming electromagnetic radiation receivable by the electromagnetic radiation out-coupling (104) element, the first electromagnetic radiation emitting unit optionally functioning as pump laser for the nanowire.

E4. The microdevice (100) for emitting electromagnetic radiation according to embodiment E2, wherein the electromagnetic radiation out-coupling (104) element has a tapered structure, the narrow end of the tapered structure being structurally connected to said nanowire.

E5. The microdevice (100) for emitting electromagnetic radiation according to embodiment E2, or E4, wherein the nanowire has a tapered structure, preferably the wider end of the tapered structure being structurally connected to said first electromagnetic radiation emitting unit, or said tapered electromagnetic radiation out-coupling (104) element when dependent on embodiment E4, the narrow end of the tapered structure of the nanowire being arranged for emitting electromagnetic radiation.

E6. The microdevice (100) for emitting electromagnetic radiation according to embodiment E1, wherein the nanowire is chosen from the group consisting of: a metallic nanowire, a semiconductor nanowire, a ceramic nanowire, an insulator nanowire, a molecular nanowire, such as nanotubes (incl. carbon nanotubes).

E7. The microdevice (100) for emitting electromagnetic radiation according to embodiment E1, wherein the nanowire in material having an effective refractive index substantially larger than an effective refractive index of the first electromagnetic radiation emitting unit, preferably with a graded transition between the two refractive indexes.

E8. The microdevice (100) for emitting electromagnetic radiation according to embodiment E1, wherein the nanowire is further optically arranged for receiving electromagnetic radiation from an associated object and transmit it to the first electromagnetic radiation emitting unit, the unit also being arranged for transmitting the said electromagnetic radiation out of the microdevice, the microdevice thereby functioning as a bi-directional optically device.

E9. The microdevice (100) for emitting electromagnetic radiation according to embodiment E1, wherein the nanowire is manufactured in a biofriendly material suitable for endoscopic application, such as SnO₂, and graphene.

E10. The microdevice (100) for emitting electromagnetic radiation according to embodiment E1, wherein the electromagnetic radiation in-coupling element (102) is arranged to receive incoming electromagnetic radiation having a first direction and the electromagnetic radiation out-coupling element (104) is arranged to emit electromagnetic radiation having a second direction where the first direction and the second direction are non-parallel, alternatively the first direction and the second direction are parallel but displaced, more alternatively where the first direction and the second direction are anti-parallel.

E11. The microdevice (100) for emitting electromagnetic radiation according to embodiment E1, wherein the microdevice comprises an electromagnetic radiation guiding element (106) optically connecting at least the electromagnetic radiation in-coupling element with the electromagnetic radiation out-coupling element.

E12. The microdevice (100) for emitting electromagnetic radiation according to embodiment E1, wherein the means (108, 110, 112, 114) for enabling spatial control over the microdevice comprise at least one electromagnetic radiation controllable handle.

E13. The microdevice (100) for emitting electromagnetic radiation according to embodiment E1, wherein the microdevice further comprises a plurality of nanowires, at least one nanowire being arranged for receiving electromagnetic radiation emitted from the first electromagnetic radiation emitting unit and emitting electromagnetic radiation, optionally at least one nanowire further being optically arranged for receiving electromagnetic radiation and transmit it to the first electromagnetic radiation emitting unit.

E14. A microdevice (100) for receiving electromagnetic radiation from an associated object, the microdevice comprising
a first electromagnetic radiation receiving unit arranged to receive and further transmit electromagnetic radiation, and
means for enabling simultaneous non-contact spatial control over the microdevice in terms of:
   translational movement in three dimensions, and
   rotational movement around at least two axes, preferably three axes,
      wherein the means for enabling non-contact spatial control over the microdevice are arranged for being spatially controlled by forces applied by electromagnetic radiation,
      wherein the first electromagnetic radiation receiving unit and the means for enabling spatial control over the microdevice are structurally linked, and
      wherein the microdevice further comprises a nanowire (150) being arranged for receiving said electromagnetic radiation from the associated object, and transmitting the electromagnetic radiation to the first electromagnetic radiation receiving unit.

E15. A system (1000) for emitting (10001) and/or receiving (1001) electromagnetic radiation onto (226) and/or from (228) an associated object, the system having a microdevice (100) comprising:
a first electromagnetic radiation emitting and/or receiving unit (102, 104, 106), and
means for enabling simultaneous non-contact spatial control over the microdevice in terms of:
   translational movement in three dimensions, and
   rotational movement around at least two axes, preferably three axes,
      wherein the means for enabling non-contact spatial control over the microdevice are arranged for being spatially controlled by forces applied by electromagnetic radiation (230),
      wherein the first electromagnetic radiation emitting and/or receiving unit and the means for enabling spatial control over the microdevice are structurally linked, and
      wherein the microdevice further comprises a nanowire (150) being arranged for emitting and/or receiving electromagnetic radiation received and/or emitted, respectively, from the first electromagnetic radiation emitting and/or receiving unit.

E16. A method for emitting and/or receiving electromagnetic radiation onto (226) and/or from (228) an associated object using a microdevice (100), the method comprising:
providing a first electromagnetic radiation emitting and/or receiving unit (102, 104, 106) in the microdevice, and
enabling non-contact spatial control over the microdevice in terms of:
   translational movement in three dimensions, and
   rotational movement around at least two axes, preferably three axes,
      wherein the enabling of non-contact spatial control over the microdevice is provided by spatially control by forces of electromagnetic radiation (230), and wherein the microdevice further comprises a nanowire (150) being arranged for emitting and/or receiving electromagnetic radiation received and/or emitted, respectively, from the first electromagnetic radiation emitting and/or receiving unit.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims and/or embodiments E1-E16, may possibly be advantageously combined, and the mentioning of these features in different claims and/or embodiments E1-E16 does not exclude that a combination of features is not possible and advantageous.

1. A microdevice for emitting electromagnetic radiation onto an associated object, the microdevice comprising:
a first electromagnetic radiation emitting unit arranged to emit electromagnetic radiation, and
a means for enabling simultaneous non-contact spatial control over the microdevice in terms of:
translational movement in three dimensions, and
rotational movement around at least two axes,
wherein the means for enabling non-contact spatial control over the microdevice are arranged for being spatially controlled by forces applied by electromagnetic radiation,
wherein the first electromagnetic radiation emitting unit and the means for enabling spatial control over the microdevice are structurally linked, and
wherein the microdevice further comprises a nanowire being arranged for receiving electromagnetic radiation emitted from the first electromagnetic radiation emitting unit and emitting electromagnetic radiation onto said associated object.

2-19. (canceled)

20. The microdevice for emitting electromagnetic radiation according to claim 1, wherein the first electromagnetic radiation emitting unit comprises:
an electromagnetic radiation in-coupling element arranged to receive incoming electromagnetic radiation, and
an electromagnetic radiation out-coupling element being structurally linked to the electromagnetic radiation in-coupling element and the electromagnetic radiation out-coupling element being arranged to emit electromagnetic radiation in response to said incoming electromagnetic radiation,
wherein the electromagnetic radiation out-coupling element is structurally and optically connected to said nanowire for emitting electromagnetic radiation.

21. The microdevice for emitting electromagnetic radiation according to claim 20, wherein the electromagnetic radiation out-coupling element is structurally and optically connected to said nanowire for emitting electromagnetic radiation, the nanowire further being optically and structurally arranged for performing lasing with an appropriate incoming electromagnetic radiation receivable by the electromagnetic radiation out-coupling element, the first electromagnetic radiation emitting unit optionally functioning as pump laser for the nanowire.

22. The microdevice for emitting electromagnetic radiation according to claim 20, wherein the electromagnetic radiation out-coupling element has a tapered structure, wherein the narrow end of the tapered structure is structurally connected to said nanowire.

23. The microdevice for emitting electromagnetic radiation according to claim 20, wherein the nanowire has a tapered structure, the narrow end of the tapered structure of the nanowire being arranged for emitting electromagnetic radiation.

24. The microdevice for emitting electromagnetic radiation according to claim 1, wherein the nanowire is selected from the group consisting of: a metallic nanowire, a semiconductor nanowire, a ceramic nanowire, an insulator nanowire, and a molecular nanowire.

25. The microdevice for emitting electromagnetic radiation according to claim 1, wherein the nanowire material has an effective refractive index substantially larger than an effective refractive index of the first electromagnetic radiation emitting unit.

26. The microdevice for emitting electromagnetic radiation according to claim 1, wherein the nanowire is further optically arranged for receiving electromagnetic radiation from an associated object and transmit it to the first electromagnetic radiation emitting unit, the unit also being arranged for transmitting the said electromagnetic radiation out of the microdevice, the microdevice thereby functioning as a bi-directional optically device.

27. The microdevice for emitting electromagnetic radiation according to claim 1, wherein the nanowire is manufactured in a biofriendly material suitable for endoscopic application, SnO₂, or graphene.

28. The microdevice for emitting electromagnetic radiation according to claim 20, wherein the electromagnetic radiation in-coupling element is arranged to receive incoming electromagnetic radiation having a first direction and the electromagnetic radiation out-coupling element is arranged to emit electromagnetic radiation having a second direction, wherein the first direction and the second direction are non-parallel, or the first direction and the second direction are parallel but displaced, or wherein the first direction and the second direction are anti-parallel.

29. The microdevice for emitting electromagnetic radiation according to claim 20, wherein the microdevice comprises an electromagnetic radiation guiding element optically connecting at least the electromagnetic radiation in-coupling element with the electromagnetic radiation out-coupling element.

30. The microdevice for emitting electromagnetic radiation according to claim 1, wherein the means for enabling spatial control over the microdevice comprise at least one electromagnetic radiation controllable handle.

31. The microdevice for emitting electromagnetic radiation according to claim 1, wherein the microdevice further comprises a plurality of nanowires, at least one nanowire being arranged for receiving electromagnetic radiation emitted from the first electromagnetic radiation emitting unit and emitting electromagnetic radiation, optionally at least one nanowire further being optically arranged for receiving electromagnetic radiation and transmit it to the first electromagnetic radiation emitting unit.

32. A microdevice for receiving electromagnetic radiation from an associated object, the microdevice comprising:
a first electromagnetic radiation receiving unit arranged to receive and further transmit electromagnetic radiation, and
means for enabling simultaneous non-contact spatial control over the microdevice in terms of:
translational movement in three dimensions, and
rotational movement around at least two axes, preferably three axes,
wherein the means for enabling non-contact spatial control over the microdevice are arranged for being spatially controlled by forces applied by electromagnetic radiation,
wherein the first electromagnetic radiation receiving unit and the means for enabling spatial control over the microdevice are structurally linked, and
wherein the microdevice further comprises a nanowire being arranged for receiving said electromagnetic radiation from the associated object, and transmitting the electromagnetic radiation to the first electromagnetic radiation receiving unit.

33. A system for emitting and/or receiving electromagnetic radiation onto and/or from an associated object, the system comprising:
a microdevice for emitting electromagnetic radiation onto an associated object according to claim 1.

34. A system according to claim 33, wherein the system further comprises:
a second electromagnetic radiation emitting unit being adapted to generate electromagnetic radiation for spatially controlling and thereby optically manipulating the microdevice for emitting electromagnetic radiation onto an associated object according to claim 1.

35. The system according to claim 33, wherein the system further comprises:
an optical unit,
wherein the optical unit is capable of
providing electromagnetic radiation for re-emission by the microdevice for emitting electromagnetic radiation onto an associated object according to claim 1.

36. The system according to claim 32, wherein the system further comprises:
a control unit or computer software running on dedicated computers and visualisation.

37. A method for emitting and/or receiving electromagnetic radiation onto and/or from an associated object using a microdevice, the method comprising:
providing a first electromagnetic radiation emitting and/or receiving unit in the microdevice, and
enabling non-contact spatial control over the microdevice in terms of:
translational movement in three dimensions, and
rotational movement around at least two axes, preferably three axes,
wherein the enabling of non-contact spatial control over the microdevice is provided by spatially control by forces of electromagnetic radiation, and
wherein the microdevice further comprises a nanowire being arranged for emitting and/or receiving electromagnetic radiation received and/or emitted, respectively, from the first electromagnetic radiation emitting and/or receiving unit.
